(19) United States
(12) Patent Application Publication
(10) Pub. No.: US 2007/0007346 A1
(43) Pub. Date: Jan. 11, 2007

(54) Complex multi-function card reader

(76) Inventor: Chia-Hsun Lin, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/174,636

(22) Filed: Jul. 6, 2005

(51) Int. Cl. G06K 7/06

(52) U.S. Cl. 235/441

(57) ABSTRACT

The present invention provides a complex multi-function card reader comprising a memory card module and an IC chip card module. The memory card module has at least a memory card connector; and the IC chip card module has at least an IC chip card connector. Those connectors are connecting with a plurality of peripheral circuit elements within the complex multi-function card reader and utilizing a transmission interface to electrically connect with electronic equipment. The present invention is to provide the user accessing all kinds of memory cards and the smart IC card in personal computer, notebook, the ATM, the multimedia player, the LCD TV, and the Internet phone.

### BACKGROUND OF THE INVENTION

1. Field of the Invention

The present invention generally relates to a card reader system, and more particularly relates to a complex multi-function card reader for accessing all kinds of memory cards and IC chip cards.

2. Description of the Prior Art

With the more and more popular trend of the portable equipments with the flash memory, the amount and the type of the flash memory cards for specific equipments become huge and various. However, the rapid development of the integrated circuit makes the data-storage ability of the memory card grow with each passing day. Recently, in order to protect the personal private matters, the IC chip card (smart IC chip card) with more powerful function is gradually replacing the magnetic card to become the main stream of the related finance card and personal data card, such as health insurance card, chip credit card, chip cash card, and chip ID card, and commonly used in the future.

Card reader is a device for accessing the data within the card, in order to access the data within the card, the card reader requires a connector to electrically connect with the electronics elements or equipments. In general, the operation of the card reader is utilizing its microprocessor to manage the input/output data and its transmission control protocol (TCP) there between. The microprocessor can be used as the microcomputer interface.

Generally, the data-accessing method of the card reader is to insert the card into the connector socket of the card reader and utilizes the connection of card reader and the computer to transmit the data within the card. Currently, the common memory cards are various and it is the same condition to memory card readers. Furthermore, there are also many kinds of chip card readers. With more and more cards for different purposes and different types, the current user require to use different card reader systems to transmit data or to do the on-line promptly finance consumption.

Hence, the main spirit of the present invention is to provide a complex multi-function card reader, and then some disadvantages of well-known technology are overcome.

### SUMMARY OF THE INVENTION

The primary object of the present invention is to provide the user easily operating and accessing the content of all kinds of cards without bringing different card readers.

Another object of the present invention is to provide the user access all kinds of memory cards and the smart IC card in personal computer, notebook, the ATM, the multimedia player, the LCD TV, and the Internet phone.

In order to achieve previous objects, the present invention provides a complex multi-function card reader comprising a memory card module having at least a memory card connector; and an IC chip card module having at least an IC chip card connector, wherein the memory card connector and the IC chip card connector are connecting with a plurality of peripheral circuit elements within the complex multi-function card reader and utilizing a transmission interface to electrically connect with an electronic equipment.

The present invention provides a complex multi-function card reader comprising a memory card/IC chip card module, wherein the memory card/IC chip card module has at least a multi-function card connector for connecting with a plurality of peripheral circuit elements within the complex multi-function card reader and utilizing a transmission interface to electrically connect with an electronic equipment.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the complex multi-function card reader, in accordance with one embodiment of the present invention;

FIG. 2 is a schematic representation of the complex multi-function card reader, in accordance with another embodiment of the present invention; and

FIG. 3 is a schematic representation of the complex multi-function card reader, in accordance with other embodiment of the present invention.

### DESCRIPTION OF THE PREFERRED EMBODIMENT

The present invention discloses a complex multi-function card reader and its embodiment therein. The detailed description is in the following, but not to be limited to the particular form disclosed.

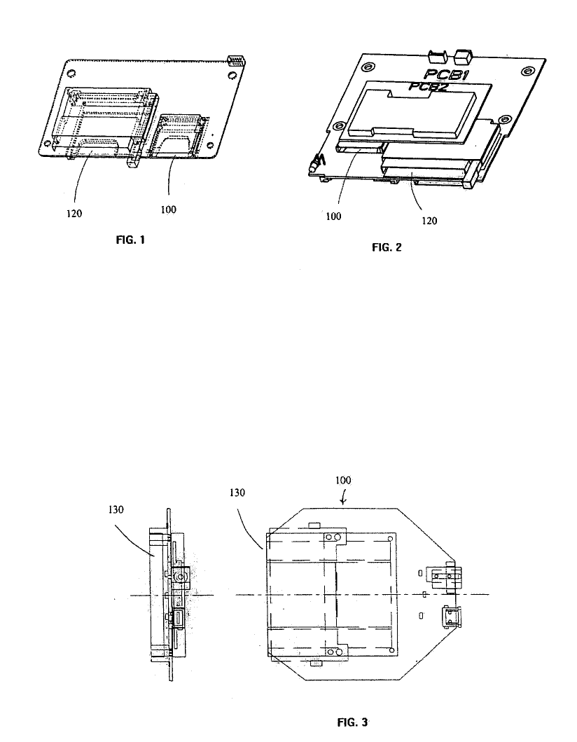

Referring to FIG. 1, a complex multi-function card reader module 100 comprises a memory card module 110 and an IC chip card module 120 arranged on a printed circuit board or a laminate. The memory card module 110 and the IC chip card module 120 can be stacked to save the space. The memory card module 110 has at least a memory card connector and the IC chip card module 120 has at least an IC chip card connector. Wherein, the memory card connector and the IC chip card connector are connecting with a plurality of peripheral circuit elements within the complex multi-function card reader and utilizing a transmission interface to electrically connect with an electronic equipment.

The memory card module has a socket for inserting a memory card to connect with the memory card connector. The memory card connector and the IC chip card connector are connecting with a plurality of peripheral circuit elements within the complex multi-function card reader and utilizing a transmission interface to electrically connect with an electronic equipment. Besides, the IC chip card module 12 has a socket for inserting an IC chip card to connect with the IC chip card connector. The IC chip card connector is suitable for using health insurance chip card, finance chip card, ID chip card and other smart chip card.

Furthermore, referring to FIG. 2, the module 100 of another embodiment of the present invention, the memory card module 110 and the IC chip card module 120 can be respectively arranged on two printed circuit boards or laminates.

Referring to FIG. 3, the module 100 of the other embodiment of the present invention, the complex multi-function card reader comprises a memory card/IC chip card module 130, wherein the memory card/IC chip card module 130 has at least a multi-function card connector for connecting with a plurality of peripheral circuit elements within the complex multi-function card reader and utilizing a transmission interface to electrically connect with an electronic equipment. The memory card/IC chip card module 130 is arranged on a printed circuit board or the laminate. The multi-function card connector is suitable for using Memory Stick Card, MS Pro, Secure Digital Card, Mini SD Card, Multi Media Card, MMC 4.0, RSMMC, RSMMC 4.0, Trans Flash Card, Smart Media Card, xD Picture Card, Compact Flash Card, Micro Drive, other kinds of flash memory cards, health insurance chip card, finance chip card, ID chip card and other smart chip card. The memory card/IC chip card module has a socket for inserting a card to connect with the multi-function card connector.

The complex multi-function card reader of the present invention can be an internal type, a fixed type, a removable type, or an external stand-alone type. The present invention also can apply to personal computer, notebook, the ATM, the multimedia player, the LCD TV, and the Internet phone.

Hence, the advantage of the present invention is to provide the multi-function for the user. As the user using the present invention, the user only requires one complex multi-function card reader without bringing different type card readers for different cards.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A complex multi-function card reader comprising:
a memory card module having at least a memory card connector; and
an IC chip card module having at least an IC chip card connector, wherein said memory card connector and said IC chip card connector are connecting with a plurality of peripheral circuit elements within said complex multi-function card reader and utilizing a transmission interface to electrically connect with an electronic equipment.

2. The complex multi-function card reader according to claim 1, wherein said memory card module has a socket for inserting a memory card to connect with said memory card connector.

3. The complex multi-function card reader according to claim 1, wherein said memory card connector is suitable for using Memory Stick Card, MS Pro, Secure Digital Card, Mini SD Card, Multi Media Card, MMC 4.0, RSMMC, RSMMC 4.0, Trans Flash Card, Smart Media Card, xD Picture Card, Compact Flash Card, Micro Drive and other kinds of flash memory cards.

4. The complex multi-function card reader according to claim 1, wherein said IC chip card module has a socket for inserting a IC chip card to connect with said IC chip card connector.

5. The complex multi-function card reader according to claim 1, wherein said IC chip card connector is suitable for using health insurance chip card, finance chip card, ID chip card and other smart chip card.

6. The complex multi-function card reader according to claim 1, wherein said memory card module and said IC chip card module are arranged on a printed circuit board.

7. The complex multi-function card reader according to claim 1, wherein said memory card module and said IC chip card module are respectively arranged on two different printed circuit boards.

8. The complex multi-function card reader according to claim 1, wherein said complex multi-function card reader can be an internal type, a fixed type, a removable type, or an external stand alone type.

9. A complex multi-function card reader comprising a memory card/IC chip card module, wherein said memory card/IC chip card module has at least a multi-function card connector for connecting with a plurality of peripheral circuit elements within said complex multi-function card reader and utilizing a transmission interface to electrically connect with an electronic equipment.

10. The complex multi-function card reader according to claim 9, wherein said memory card/IC chip card module has a socket for inserting a card to connect with said multi-function card connector.

11. The complex multi-function card reader according to claim 9, wherein said multi-function card connector is suitable for using Memory Stick Card, MS Pro, Secure Digital Card, Mini SD Card, Multi Media Card, MMC 4.0, RSMMC, RSMMC 4.0, Trans Flash Card, Smart Media Card, xD Picture Card, Compact Flash Card, Micro Drive, other kinds of flash memory cards, health insurance chip card, finance chip card, ID chip card and other smart chip card.

12. The complex multi-function card reader according to claim 9, wherein said memory card/IC chip card module is arranged on a printed circuit board.

13. The complex multi-function card reader according to claim 9, wherein said complex multi-function card reader can be an internal type, a fixed type, a removable type, or an external stand alone type.
